(19) United States
(12) Patent Application Publication
(10) Pub. No.: US 2020/0189334 A1
(43) Pub. Date: Jun. 18, 2020

(54) Crawler-type Adjustable Anti-skid Device for Vehicles Which Can Be Quickly Connected

(71) Applicant: Fat Ming Cheung, Hong Kong (HK)

(72) Inventor: Fat Ming Cheung, Hong Kong (HK)

(21) Appl. No.: 16/259,031

(22) Filed: Jan. 28, 2019

(30) Foreign Application Priority Data
Dec. 17, 2018 (CN) 201811539832.5

(51) Int. Cl. B60C 27/02

(52) U.S. Cl. CPC B60C 27/0269; B60C 27/003; B60C 27/0238

(57) ABSTRACT

The invention relates to a crawler-type adjustable anti-skid device for vehicles which can be quickly connected. The device includes a support base, a crawler mechanism and a transmission mechanism. The support base includes a support plate, a side plate, a guide plate disposed above the support plate, a guide rail, a connecting member, a baffle and a guide cable. The crawler mechanism includes a crawler wheel, a crawler body and a single type of hydraulic cylinder. The transmission mechanism is symmetrically arranged on the support plate. The device has simple and reasonable structure, easy to use, automatic positioning, safe and reliable and can be quickly installed, and does not need extra modification, etc. which effectively solves the problem that vehicles lack safe and reliable anti-skid device which can be quickly connected.

### FIELD OF THE INVENTION

The invention relates to the field of anti-skid devices for vehicles, in particular to a crawler-type adjustable anti-skid device for vehicles which can be quickly connected.

### BACKGROUND

In the known technology, the walking mode of the vehicle is generally divided into two types: a wheel type and a crawler type. The crawler type vehicle has good stability and strong anti-skid performance, but the structure of the crawler traveling mechanism is relatively complicated, the maintenance is relatively troublesome, and the damage to the road is more serious. Therefore, wheeled vehicles are used in most cases in daily life, but the anti-skid performance of ordinary wheeled vehicles is far less than that of crawler-type vehicles. In the case of rainy and snowy weather and other cases where the road surface is slippery, specific anti-skid tires are required to be used. Of course, the crawler type travelling mechanism may be also used, but these replacement work requires certain technical and equipment support. It is not only troublesome to replace the travelling mechanism, but also the driving angle of the traveling mechanism may jeopardize the safety of driving if there is a problem, so it is necessary to develop an safe and reliable anti-skid device with automatic positioning which can be quickly installed.

### SUMMARY OF THE INVENTION

The technical problem to be solved is to overcome the above-mentioned deficiency by providing a crawler-type adjustable anti-skid device for vehicles which can be quickly connected. The device has simple and reasonable structure, easy to use, automatic positioning, safe and reliable and can be quickly installed, and does not need extra modification, etc. which effectively solves the problem that vehicles lack safe and reliable anti-skid device which can be quickly connected.

The technical solution of the present invention is to provide a crawler-type adjustable anti-skid device for vehicles which can be quickly connected. The device includes a support base, a crawler mechanism and a transmission mechanism. The support base includes a support plate, two side plates symmetrically disposed under the support plate, a guide plate disposed above the support plate, a guide rail, a connecting member, a baffle and a guide cable.

The guide rail is respectively disposed on two sides of the support plate connecting side plates, and the guide rail is provided with a guide wheel that is rotatably connected with the side of the wheel. The baffle and the guide cable are respectively symmetrically disposed on the other two sides of the support plate. One end of the baffle is hinged to the support plate through a damper shaft, and the other end of the baffle is engaged with the support plate.

One end of the guide cable is connected with the support plate, and the other end of the guide cable is connected with the vehicle chassis through a safety buckle. The guide cable is further provided with an elastic adjusting member. The elastic adjusting member includes a first housing, a second housing which is threadedly connected to the first housing, sliding rods disposed in the inner cavity of the first housing and the second housing, and a first spring sleeved on the sliding rod. The sliding rods extending from the first housing, and the second housing are respectively connected to the guide cable.

Two sides of the guide plate are provided with an extending edge, and the extending edge is provided with a through groove. The through groove is hinged with a movable column disposed on the side plate. One end of the movable column extends from the side plate and is sleeved to the second spring. Two ends of the second spring respectively abut the movable column and the support plate.

The crawler mechanism is disposed under the support plate, and the crawler mechanism includes a plurality of crawler heels and a crawler body. The crawler wheels are connected by a hinge plate to form a ring shape, and the single type of hydraulic cylinder is connected between the upper and lower crawler wheels.

The transmission mechanism is symmetrically disposed on the support plate, the support plate is provided with a groove. The groove is provided with a sliding plate, and the sliding plate is provided with a first rotating shaft and a second rotating shaft. The first rotating shaft and the second rotating shaft are sleeved to a transmission belt abutting against the bottom surface of the wheel. The side wall of the sliding plate and the groove is provided with a threaded rod, and the threaded rod is screwed through a second threaded sleeve disposed in the groove. The second rotating shaft is close to the baffle. The second rotating shaft cooperates with the first rotating shaft such that the transmission belt is inclined toward the middle of the support plate, and the second rotating shaft is drivingly connected to the crawler wheel through the transmission member.

Further, one end of the baffle and the support plate are hinged to each other through a damper shaft, and the other end of the baffle is engaged with a U-shaped elastic snap member disposed on the support plate.

Further, the sliding rod is provided with a convex ring which prevents the sliding rod from extending out of the inner cavity of the first housing and the second casing. The two ends of the first spring abut the convex ring and the first housing, respectively.

Further, the connecting member includes a connecting flange fixedly connected to the wheel, an upper connecting rod rotatably connected to the connecting flange, a lower connecting rod fixedly connected to the support plate, and a first threaded sleeve connected to the upper connecting rod and the lower connecting rod by threads.

Further, one or more guide ring grooves are respectively disposed on the first rotating shaft and the second rotating shaft.

Further, the bottom surface of the transmission belt is provided with a guide rib adapted to the guide ring groove, and the guide rib has a semicircular structure.

Further, the upper surface of the transmission belt is provided with an anti-skid groove.

The technical effect of the present invention is to provide a crawler-type adjustable anti-skid device for vehicles which can be quickly connected. The device includes a support base, a crawler mechanism and a transmission mechanism. The crawler mechanism is disposed under the support base to fully utilize the anti-slip performance of the crawler traveling mechanism. The transmission mechanism is disposed above the support base to connect with the wheel, and transmits the kinetic energy generated by the rotation of the wheel to the crawler mechanism. The support base separates the crawler mechanism from the transmission mechanism. A baffle is arranged in the direction of the wheel to prevent muddy water, snow, etc. from entering the wheel and the transmission device to prevent slipping. The support base is provided with multiple connections with the wheel and the vehicle chassis to prevent the wheel from being detached from the present invention. The guide wheel mounted on the guide rail guides the installation position of the wheel when the wheel enters, ensuring that the installation position is correct. The device has simple and reasonable structure, easy to use, automatic positioning, safe and reliable and can be quickly installed, and does not need extra modification, etc. which effectively solves the problem that vehicles lack safe and reliable anti-skid device which can be quickly connected.

### BRIEF DESCRIPTION OF THE DRAWINGS

The invention is illustrated by the following figures and embodiments.

FIG. 1 shows a schematic diagram of outside structure of a crawler-type adjustable anti-skid device for vehicles which can be quickly connected in accordance with an example embodiment.

FIG. 2 shows a schematic diagram of inside structure of a crawler-type adjustable anti-skid device for vehicles which can be quickly connected in accordance with an example embodiment.

FIG. 3 shows a schematic diagram of installation structure of a movable column of a crawler-type adjustable anti-skid device for vehicles which can be quickly connected in accordance with an example embodiment.

FIG. 4 shows a schematic diagram of a connecting member of a crawler-type adjustable anti-skid device for vehicles which can be quickly connected in accordance with an example embodiment.

FIG. 5 shows a schematic diagram of an elastic adjusting member of a crawler-type adjustable anti-skid device for vehicles which can be quickly connected in accordance with an example embodiment.

FIG. 6 shows a schematic diagram of a transmission mechanism of a crawler-type adjustable anti-skid device for vehicles which can be quickly connected in accordance with an example embodiment.

FIG. 7 shows a schematic diagram of a first rotating shaft and a transmission belt of a crawler-type adjustable anti-skid device for vehicles which can be quickly connected in accordance with an example embodiment.

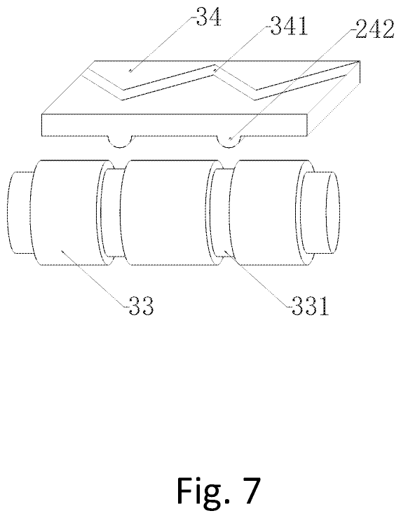

The reference numbers of the figures are as follows:

1: support base; 11: side plate; 12: support plate; 2: crawler mechanism; 20: single type of hydraulic cylinder; 21: crawler wheel; 211: hinge plate; 22: crawler body; 23: guide plate; 231: through groove; 24: movable column; 241: second spring; 242: guide rib; 25: guide rail; 251: guide wheel; 26: connecting member; 261: connecting flange; 262: upper connecting rod; 263: first threaded sleeve; 264: lower connecting rod; 27: baffle; 28: guide cable; 29: elastic adjusting member; 291: first housing; 292: second housing; 293: sliding rod; 294: first spring; 3: transmission mechanism; 31: sliding plate; 311: threaded rod; 32: second threaded sleeve; 33: first rotating shaft; 331: guide ring groove; 34: transmission belt; 341: anti-skid groove; 35: second rotating shaft; 36: transmission member; 4: wheel; 5: vehicle chassis.

### DETAILED DESCRIPTION

The invention is illustrated in accordance with figures. The figures as simplified diagrams demonstrate the basic structures of the apparatus of embodiments of the invention. Thus; the invention is not limited to the figures.

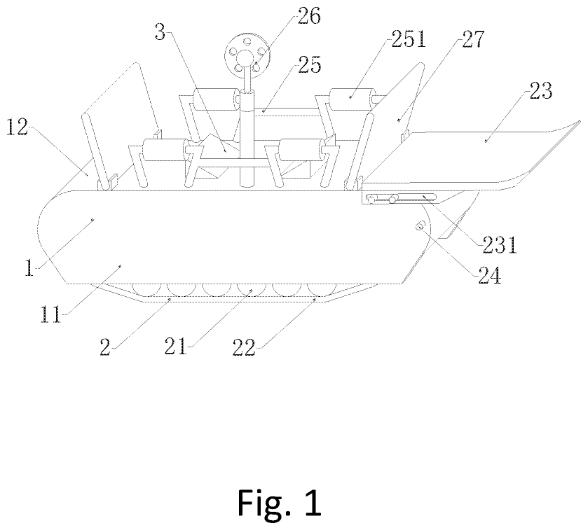

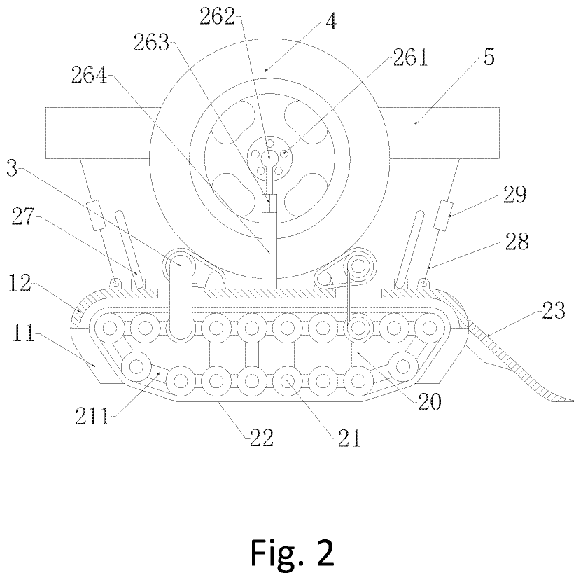

As shown in FIGS. 1 and 2, a crawler-type adjustable anti-skid device for vehicles which can be quickly connected, includes a support base 1, a crawler mechanism 2 and a transmission mechanism 3.

The support base 1 includes a support plate 12, two side plates 11 symmetrically disposed under the support plate 12, a guide plate 23 disposed above the support plate 12, a guide rail 25, a connecting member 26, a baffle 27 and a guide cable 28.

The guide rail 25 is respectively disposed on two sides of the support plate 12 connecting side plates 11. In other words, the guide rail 25 and the side plate 11 are disposed on the upper and lower sides of the same two sides of the support plate 12. The guide rail 25 is provided with a guide wheel 251 that is rotatably connected with the side of the wheel 4. When the wheel 4 enters the passage surrounded by the guide rail 25, the guide rail 25 and the guide wheel 251 cooperate to guide and correct the position of the wheel 4. In order to achieve a better guiding correction effect, the guide wheel 251 includes but is not limited to the roller disposed on the guide rail 25 and the spherical ball disposed in the direction of the wheel 4, or any component which can be rotatably connected to the guide rail 25.

The baffle 27 and the guide cable 28 are respectively symmetrically disposed on the other two sides of the support plate 12, i.e. in the direction which the wheel 4 advances or retreats. One end of the baffle 27 is hinged to the support plate 12 through a damper shaft, and the other end of the baffle 27 is engaged with the support plate 12. In other words, the baffle 27 may open towards one side so that the vehicles can pass.

One end of the guide cable 28 is connected with the support plate 12, and the other end of the guide cable 28 is connected with the vehicle chassis 5 through a safety buckle. The guide cable 28 is further provided with an elastic adjusting member 29.

Two sides of the guide plate 23 are provided with an extending edge, and the extending edge is provided with a through groove 231. The through groove 231 is hinged with a movable column 24 disposed on the side plate 11. The movable column 24 can be retracted inwardly. In use, different movable columns 24 are selected to be connected with the guide plates 23 to change the angle of the guide plates 23. For example, when the guide plates 23 are inclined to touch the ground, the wheels can enter or exit from the installation position. When the guide plate 23 is horizontal, it can be retracted and stored by the through groove 231, and the remaining overhanging portion is in contact with the snow to provide an upward force, preventing the tilt of the present invention from causing the wheel 4 to come out of the installation position, in order to achieve a better guiding effect. In an embodiment, the guide plates 23 are mounted at both ends in the advancing direction of the wheel, and the overhanging portions thereof are slightly upturned.

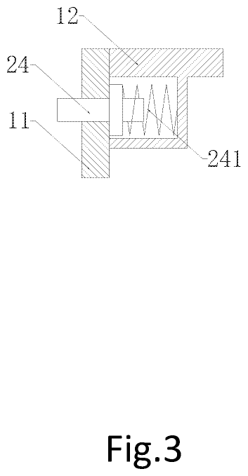

As shown in FIG. 3, one end of the movable column 24 extends from the side plate 11 and is sleeved to the second spring 241. Two ends of the second spring 241 respectively abut the movable column 24 and the support plate 12.

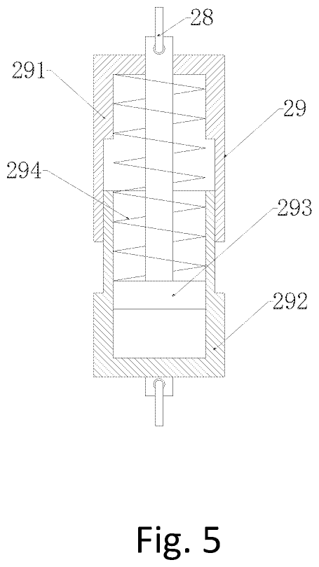

As shown in FIG. 5, the elastic adjusting member 29 includes a first housing 291, a second housing 292 which is threadedly connected to the first housing 291, sliding rods 293 disposed in the inner cavity of the first housing 291 and the second housing 292, and a first spring 294 sleeved on the sliding rod 293. The sliding rods 293 extending from the first housing 291, and the second housing 292 are respectively connected to the guide cable 28.

After the guide cable 28 at both ends are connected, the tightness of the guide cable 28 is further adjusted by rotating the first housing 291 and the second housing 292. During the running of the vehicle, the first spring 294 and the sliding rod 293 cooperate with each other to make the present invention cause a certain angle of front and rear tilt when the condition permits.

As shown in FIG. 2, the crawler mechanism 2 is disposed under the support plate 12, and the crawler mechanism 2 includes a plurality of crawler wheels 21 and a crawler body 22. The crawler wheels 21 are connected by a hinge plate 21 to form a ring shape, and the single type of hydraulic cylinder 20 is connected between the upper and lower crawler wheels 21. The single type of hydraulic cylinder 20 is used for the damping of the crawler mechanism 2, and can also be used to adjust its height to suit different terrains.

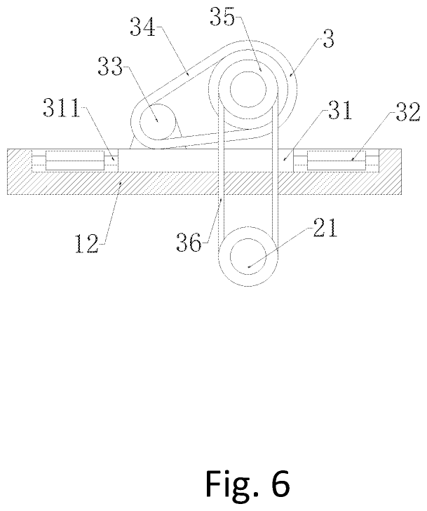

As shown in FIGS. 2 and 6, the transmission mechanism 3 is symmetrically disposed on the support plate 12, the support plate 12 is provided with a groove. The groove is provided with a sliding plate 31, and the sliding plate 31 is provided with a first rotating shaft 33 and a second rotating shaft 35. The first rotating shaft 33 and the second rotating shaft 35 are sleeved to a transmission belt 34 abutting against the bottom surface of the wheel 4. The side wall of the sliding plate 31 and the groove is provided with a threaded rod 311, and the threaded rod 311 is screwed through a second threaded sleeve 32 disposed in the groove. Adjusting the position of the sliding plate 31 on the support plate 12 by rotating the second threaded sleeve 32 to accommodate different sized wheels.

The second rotating shaft 35 is close to the baffle 27. The second rotating shaft 35 cooperates with the first rotating shaft 33 such that the transmission belt 34 is inclined toward the middle of the support plate. At least two symmetrically disposed transmission mechanisms 3 form a wheel recessed position on the support plate 12. The second rotating shaft 35 is drivingly connected to the crawler wheel 21 through the transmission member 36. The transmission member 36 herein refers to a chain transmission member or a belt transmission member, and may of course be a transmission rod member.

In an example embodiment, one end of the baffle 27 and the support plate 12 are hinged to each other through a damper shaft, and the other end of the baffle 27 is engaged with a U-shaped elastic snap member disposed on the support plate 12.

In an example embodiment as shown in FIG. 5, the sliding rod 293 is provided with a convex ring which prevents the sliding rod from extending out of the inner cavity of the first housing 291 and the second casing 292. The two ends of the first spring 294 abut the convex ring and the first housing 291, respectively.

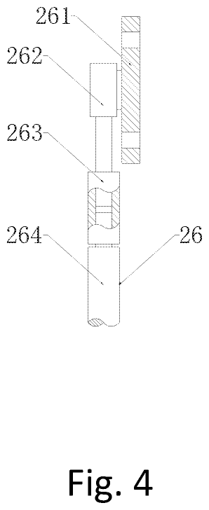

In an example embodiment as shown in FIG. 4, the connecting member 26 includes a connecting flange 261 fixedly connected to the wheel 4, an upper connecting rod 262 rotatably connected to the connecting flange 261, a lower connecting rod 264 fixedly connected to the support plate 12, and a first threaded sleeve 263 connected to the upper connecting rod 262 and the lower connecting rod 264 by threads. The connecting flange 261 is connected with the mounting bolt of the wheel 4 or is engaged with the hole of the hub by the engaging member. The connecting flange 261 and the upper connecting rod 262 are rotatably connected to each other through the ball joint or the bearing, and the connection point is located on the central axis of the vehicle axle.

In an example embodiment as shown in FIG. 4, one or more guide ring grooves 331 are respectively disposed on the first rotating shaft 33 and the second rotating shaft 35. The guide ring groove 331 should be symmetrically disposed on the first rotating shaft 33 and/or the second rotating shaft 35.

In an example embodiment as shown in FIG. 4, the bottom surface of the transmission belt 34 is provided with a guide rib 242 adapted to the guide ring groove 331, and the guide rib 242 has a semicircular structure. The semicircular structure is more easily guided into the guide ring groove 331 and is less likely to come out because it is caught by the side of the guide ring groove 331.

In an example embodiment as shown in FIG. 4, the upper surface of the transmission belt 34 is provided with an anti-skid groove 341 or non-skid projections. The non-skid projections include tenons and/or metal attachments.

The crawler-type adjustable anti-skid device for vehicles which can be quickly connected of the present invention has a simple and reasonable structure, and includes a support base, a crawler mechanism and a transmission mechanism. The crawler mechanism is disposed under the support base to fully utilize the anti-slip performance of the crawler traveling mechanism. The transmission mechanism is disposed above the support base to connect with the wheel, and transmits the kinetic energy generated by the rotation of the wheel to the crawler mechanism. The support base separates the crawler mechanism from the transmission mechanism. A baffle is arranged in the direction of the wheel to prevent muddy water, snow, etc. from entering the wheel and the transmission device to prevent slipping. The support base is provided with multiple connections with the wheel and the vehicle chassis to prevent the wheel from being detached from the present invention. The guide wheel mounted on the guide rail guides the installation position of the wheel when the wheel enters, ensuring that the installation position is correct. The device has simple and reasonable structure, easy to use, automatic positioning, safe and reliable and can be quickly installed, and does not need extra modification, etc. which effectively solves the problem that vehicles lack safe and reliable anti-skid device which can be quickly connected.

The exemplary embodiments of the present invention are thus fully described. Although the description referred to particular embodiments; it will be clear to one skilled in the art that the present invention may be practiced with variations of these specific details. Hence this invention should not be construed as limited to the embodiments set forth herein.

What is claimed is:

1. A crawler-type adjustable anti-skid device for vehicles which can be quickly connected, comprising: a support base 1, a crawler mechanism 2 and a transmission mechanism 3, wherein the support base 1 includes a support plate 12, two side plates 11 symmetrically disposed under the support plate 12, a guide plate 23 disposed above the support plate 12, a guide rail 25, a connecting member 26, a baffle 27 and a guide cable 28,
wherein the guide rail 25 is respectively disposed on two sides of the support plate 12 connecting side plates 11; the guide rail 25 is provided with a guide wheel 251 that is rotatably connected with the side of the wheel 4; the baffle 27 and the guide cable 28 are respectively symmetrically disposed on the other two sides of the support plate 12; one end of the baffle 27 is hinged to the support plate 12 through a damper shaft, and the other end of the baffle 27 is engaged with the support plate 12,
wherein one end of the guide cable 28 is connected with the support plate 12, and the other end of the guide cable 28 is connected with the vehicle chassis 5 through a safety buckle; the guide cable 28 is further provided with an elastic adjusting member 29; the elastic adjusting member 29 includes a first housing 291, a second housing 292 which is threadedly connected to the first housing 291, sliding rods 293 disposed in the inner cavity of the first housing 291 and the second housing 292, and a first spring 294 sleeved on the sliding rod 293; the sliding rods 293 extending from the first housing 291, and the second housing 292 are respectively connected to the guide cable 28,
wherein two sides of the guide plate 23 are provided with an extending edge, and the extending edge is provided with a through groove 231; the through groove 231 is hinged with a movable column 24 disposed on the side plate 11; one end of the movable column 24 extends from the side plate 11 and is sleeved to the second spring 241; two ends of the second spring 241 respectively abut the movable column 24 and the support plate 12,
wherein the crawler mechanism 2 is disposed under the support plate 12, and the crawler mechanism 2 includes a plurality of crawler wheels 21 and a crawler body 22; the crawler wheels 21 are connected by a hinge plate 21 to form a ring shape, and the single type of hydraulic cylinder 20 is connected between the upper and lower crawler wheels 21,
wherein the transmission mechanism 3 is symmetrically disposed on the support plate 12, the support plate 12 is provided with a groove; the groove is provided with a sliding plate 31, and the sliding plate 31 is provided with a first rotating shaft 33 and a second rotating shaft 35; the first rotating shaft 33 and the second rotating shaft 35 are sleeved to a transmission belt 34 abutting against the bottom surface of the wheel 4; the side wall of the sliding plate 31 and the groove is provided with a threaded rod 311, and the threaded rod 311 is screwed through a second threaded sleeve 32 disposed in the groove; the second rotating shaft 35 is close to the baffle 27; the second rotating shaft 35 cooperates with the first rotating shaft 33 such that the transmission belt 34 is inclined toward the middle of the support plate; the second rotating shaft 35 is drivingly connected to the crawler wheel 21 through the transmission member 36.

2. The crawler-type adjustable anti-skid device for vehicles which can be quickly connected of claim 1, wherein one end of the baffle 27 and the support plate 12 are hinged to each other through a damper shaft, and the other end of the baffle 27 is engaged with a U-shaped elastic snap member disposed on the support plate 12.

3. The crawler-type adjustable anti-skid device for vehicles which can be quickly connected of claim 1, wherein the sliding rod 293 is provided with a convex ring which prevents the sliding rod from extending out of the inner cavity of the first housing 291 and the second casing 292; the two ends of the first spring 294 abut the convex ring and the first housing 291, respectively.

4. The crawler-type adjustable anti-skid device for vehicles which can be quickly connected of claim 1, wherein the connecting member 26 includes a connecting flange 261 fixedly connected to the wheel 4, an upper connecting rod 262 rotatably connected to the connecting flange 261, a lower connecting rod 264 fixedly connected to the support plate 12, and a first threaded sleeve 263 connected to the upper connecting rod 262 and the lower connecting rod 264 by threads.

5. The crawler-type adjustable anti-skid device for vehicles which can be quickly connected of claim 1, wherein one or more guide ring grooves 331 are respectively disposed on the first rotating shaft 33 and the second rotating shaft 35.

6. The crawler-type adjustable anti-skid device for vehicles which can be quickly connected of claim 1, wherein the bottom surface of the transmission belt 34 is provided with a guide rib 242 adapted to the guide ring groove 331, and the guide rib 242 has a semicircular structure.

7. The crawler-type adjustable anti-skid device for vehicles which can be quickly connected of claim 1, wherein the upper surface of the transmission belt 34 is provided with an anti-skid groove 341.
